(19) United States
(12) Patent Application Publication
(10) Pub. No.: US 2016/0330679 A1
(43) Pub. Date: Nov. 10, 2016

(54) CELL SELECTION METHOD AND APPARATUS AND COMMUNICATION SYSTEM

(71) Applicant: FUJITSU LIMITED, Kawasaki-shi (JP)

(72) Inventors: Lei ZHANG, Beijing (CN); Weiwei WANG, Beijing (CN); Hua ZHOU, Beijing (CN)

(73) Assignee: FUJITSU LIMITED, Kawasaki-shi (JP)

(21) Appl. No.: 15/216,885

(22) Filed: Jul. 22, 2016

Related U.S. Application Data
(63) Continuation of application No. PCT/CN2014/071361, filed on Jan. 24, 2014.

(51) Int. Cl. H04W 48/16; H04W 48/10; H04W 48/20

(52) U.S. Cl. CPC H04W 48/16; H04W 48/20; H04W 48/10

(57) ABSTRACT

Embodiments of the present disclosure provides a cell selection method and apparatus and a communication system. The method includes: a base station of a cell transmits indication information to UE, the indication information indicating whether a cell covered by a base station to which the apparatus belongs is an access-only cell; the UE receives the indication information transmitted by the base station of the cell; and determines whether the cell is an access-only cell according to the indication information or according to the indication information or some other factors. With the method and apparatus and the communication system of the embodiments, the UE may determine whether to camp on/access to the cell according to the state of the cell (access-only), thereby speeding up selection or reselection of suitable cells by the UE.

### CROSS REFERENCE TO RELATED APPLICATIONS

This application is a continuation application of International Application PCT/CN2014/071361 filed on Jan. 24, 2014, the entire contents of which are incorporated herein by reference.

### FIELD

The present disclosure relates to the field of communications, and in particular to a cell selection method and apparatus and a communication system.

### BACKGROUND

A spectrum efficiency (SE) is always one of important criteria for evaluating a mobile communication system in the development of mobile communication from the first generation mobile communication to the fourth generation mobile communication. And how to improve a spectrum efficiency and hence to further improve a transmission rate of user equipment (UE) is one of problems needing to be emphatically solved during design of a mobile communication system. In a currently-discussed concept of fifth-generation mobile communication, green communication becomes a prospect of the fifth-generation mobile communication. In the wide discussion of academia and industry, besides SE, an energy efficiency (EE) is expected to be an important criterion for mobile communication.

In the former four generations of mobile communication, priority has been given to macro cells. In the future mobile communication, in order to reasonably adjust traffic demands and equipment overhead while ensuring coverage, heterogeneous deployment where a macro cell and small cells coexist will become one of major deployment scenarios of a mobile communication system, in which the macro cell is responsible for coverage of a UE, and small cells are responsible for data offloading of the UE. Typical small cells include micro cells, pico cells and femto cells. In comparison with the small cells, transmission power of a base station of the macro cell is relatively large. Correspondingly, power consumption of a power amplifier (PA) and radio frequency (RF) units of the base station of the macro cell is also very large, and in order to maintain normal operation of the base station equipment, some air-conditioning devices are needed to be equipped. Hence, the EE of the base station of the macro cell is obviously lower than that of the small cells. And the small cells are obviously advantageous in energy saving and flexible deployment.

In normal conditions, the number of UEs served by each macro cell is relatively large, hence, the total number of UEs and total uplink and downlink traffics of the whole cell tend to be stable. A coverage area of the small cells is relatively small, and the number of UEs served simultaneously by each small cell is far smaller than the number of UEs served by the macro cell. A relatively small coverage area makes time of camping on a small cell of a moving UE relatively short, even if a moving speed of the UE is relatively slow. For example, it is assumed that a diameter of a small cell is 50 m and a moving speed of a UE is 3 km/h (a walking speed), then a duration of the UE camping on the coverage of the small cell is only 60 seconds. Thus, a dynamic change of the UE in the small cell (joining in or leaving the small cell by the UE) is also very fast. Furthermore, as the number of UEs served by the small cell is relatively small, initiating a new traffic or terminating an existing traffic by any UE may possibly change demands of uplink and downlink data of the whole small cell.

The relatively fast dynamic changes of the small cells may result in unequal distribution of the number of UEs and demands for data in the small cells. For example, when a small cell operates at its full load, a neighboring small cell may be at a low-load state or even an idle state.

It should be noted that the above description of the background is merely provided for clear and complete explanation of the present disclosure and for easy understanding by those skilled in the art. And it should not be understood that the above technical solution is known to those skilled in the art as it is described in the background of the present disclosure.

### SUMMARY

Embodiments of the present disclosure provide a cell selection method and apparatus and a communication system, so as to speed up selection of suitable cells by the UE.

According to a first aspect of the embodiments of the present disclosure, there is provided a cell selection method, including:

a base station of a cell transmits indication information to UE, the indication information indicating whether a cell covered by a base station to which the apparatus belongs is an access-only cell.

According to a second aspect of the embodiments of the present disclosure, there is provided a cell selection method, including:

UE receives indication information transmitted by a base station of a cell; and

UE determines whether the cell is an access-only cell according to the indication information.

According to a third aspect of the embodiments of the present disclosure, there is provided a cell selection apparatus, including:

a transmitting unit configured to transmit indication information to UE, the indication information indicating whether a cell covered by a base station to which the apparatus belongs is an access-only cell.

According to a fourth aspect of the embodiments of the present disclosure, there is provided a cell selection apparatus, including:

a receiving unit configured to receive indication information transmitted by a base station of a cell; and

a determining unit configured to determine whether the cell is an access-only cell according to the indication information.

According to a fifth aspect of the embodiments of the present disclosure, there is provided a base station, including the cell selection apparatus as described in the third aspect.

According to a sixth aspect of the embodiments of the present disclosure, there is provided UE, including the cell selection apparatus as described in the fourth aspect.

According to a seventh aspect of the embodiments of the present disclosure, there is provided a communication system, including a base station and UE, wherein,

the base station is configured to transmit indication information to the UE, the indication information indicating whether a cell covered by the base station is an access-only cell;

and the UE is configured to receive the indication information, and determine whether the cell is an access-only cell according to the indication information.

According to another aspect of the embodiments of the present disclosure, there is provided a computer-readable program, wherein when the program is executed in a base station, the program enables the base station to carry out the cell selection method as described in the first aspect.

According to a further aspect of the embodiments of the present disclosure, there is provided a storage medium in which a computer-readable program is stored, wherein the computer-readable program enables a base station to carry out the cell selection method as described in the first aspect.

According to still another aspect of the embodiments of the present disclosure, there is provided a computer-readable program, wherein when the program is executed in UE, the program enables the UE to carry out the cell selection method as described in the second aspect.

According to yet another aspect of the embodiments of the present disclosure, there is provided a storage medium in which a computer-readable program is stored, wherein the computer-readable program enables UE to carry out the cell selection method as described in the second aspect.

An advantage of the embodiments of the present disclosure exists in that with the method and apparatus and the communication system of the embodiments, energies may be saved and inter-cell interference may be lowered in case of densely distributed cells.

With reference to the following description and drawings, the particular embodiments of the present disclosure are disclosed in detail, and the principles of the present disclosure and the manners of use are indicated. It should be understood that the scope of the embodiments of the present disclosure is not limited thereto. The embodiments of the present disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of the present disclosure, which constitute a part of the specification and illustrate the exemplary embodiments of the present disclosure, and are used for setting forth the principles of the present disclosure together with the description. It is clear and understood that the accompanying drawings in the following description are some embodiments of the present disclosure only, and a person of ordinary skill in the art may obtain other accompanying drawings according to these accompanying drawings without making an inventive effort. In the drawings:

FIG. 1 is a flowchart of an implementation of the cell selection method of an embodiment of the present disclosure;

FIG. 2 is a schematic diagram of a structure of an implementation of the cell selection apparatus of an embodiment of the present disclosure;

FIG. 3 is a schematic diagram of a structure of an implementation of the base station of an embodiment of the present disclosure;

FIG. 4 is a flowchart of another implementation of the cell selection method of the embodiment of the present disclosure;

FIG. 5 is a schematic diagram of a structure of another implementation of the cell selection apparatus of the embodiment of the present disclosure;

FIG. 6 is a schematic diagram of a structure of an implementation of the UE of an embodiment of the present disclosure; and

FIG. 7 is a schematic diagram of topology of the communication system of an embodiment of the present disclosure.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims. Various embodiments of the present disclosure shall be described below with reference to the accompanying drawings. These embodiments are illustrative only, and are not intended to limit the present disclosure.

In order to save energies and lower inter-cell interference in case of densely distributed small cells, a method for dynamically turning on/off small cells has been introduced into the LTE specifications. Such dynamically turning on/off is based on a mechanism in which cells are quickly turned on or off. When there exists no UE needing to be served in a small cell or a small cell and its surrounding small cells are all in a low-load condition, it may be taken into account to hand over current UE served by the small cell to neighboring small cells, and then turn off the small cell. When a new UE arrives at a turned off small cell, or a new data packet of an existing UE within coverage of the turned off small cell arrives, or another event satisfying a condition of turning on the small cell occurs, the small cell will be turned on, so as to serve for new UE, or offload large data packet transmission, etc.

For UE served by a dynamically turned on/off small cell, i.e. the UE is in an RRC_CONNECTED state in the small cell, influence produced by the dynamical turn-on/turn-off of the small cell is controllable. As the UE keeps connection with the small cell, the small cell may hand over the UE to a neighboring cell before it is turned off. And for UE camping on a dynamically turned on/off small cell, i.e. the UE is in an RRC_IDLE state in the small cell, influence produced by the dynamical turn-on/turn-off of the small cell may be uncontrollable, since when UE is in an idle state in a cell, the UE only keeps timing synchronization with downlink signals of the cell, regularly monitors quality of the downlink signals of the cell and monitors broadcast information and paging information of the cell. In such a case, the cell even does not know the number of UEs in the RRC_IDLE state in its coverage. An existing base station of a cell can only make as possible the UE in the IDLE state to change smoothly its camping cell by cell reselection or cell selection, but it is unable to ensure that each UE in the IDLE state to start the reselection process in time.

In order to solve this problem, one method is completely not to allow idle UE to camp on a cell that can be dynamically turned on/off. This may result in that the UE is unable to initiate a random access process of accessing to the cell on its own, but can only access to the cell by handover and be served by a base station of the cell. This is because that UE can attempt to access to the cell only after it camps on the cell, and completely not allowing idle UE to camp on a cell that can be dynamically turned on/off means that UE is unable to initiate a ransom access process of accessing to the cell on its own. In a scenario of dense deployment of small cells, a macro base station may cover multiple small cells, and in order to avoid and coordinate inter-cell interference, many of these small cells may be dynamically turned on/off. Hence, the UE being served by the small cells only by handover may result in a large quantity of unnecessary handover operations, and the handover may possibly bring extra time delay. It is shown by studies that when one or more UEs need to be served by a small cell, the more punctual the small cell starts this kind of services, the larger gains the network obtains.

In order to solve this problem, embodiments of the present disclosure propose a solution, which may not only be applicable to the dynamically turned on/off small cells in the above-described small cell system, but also be applicable to other scenarios of dense deployment of small cells, and the embodiments are not limited thereto.

The method, apparatus and system of the embodiments of the present disclosure shall be described below with reference to the accompanying drawings.

### Embodiment 1

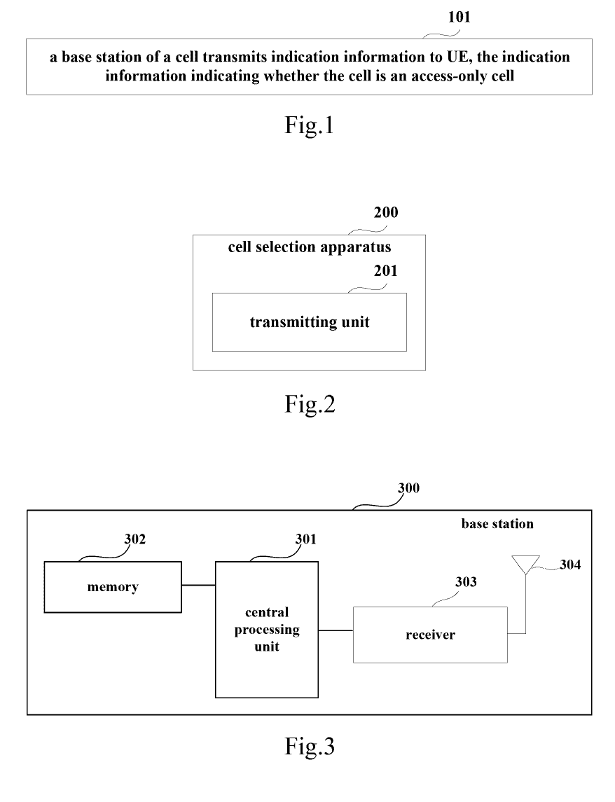

An embodiment of the present disclosure provides a cell selection method. FIG. 1 is a flowchart of the method. Referring to FIG. 1, the method includes:

step 101: a base station of a cell transmits indication information to UE, the indication information indicating whether the cell is an access-only cell.

In this embodiment, the access-only cell refers to a cell only allowing UE to camp on the cell on the purpose of access. In other words, the UE is not allowed to camp on the cell, except that the UE attempts to access to the cell immediately after camping on the cell successfully.

In this embodiment, an implementation of the attempting to access to the cell immediately may be that a timer is started after the UE camps on the cell successfully. If the UE does not initiate random access to the cell within timing of the timer, the UE performs cell reselection after the timer expires; and if the UE initiates random access to the cell within timing of the timer, the timer may be stopped immediately, and the UE may perform a normal random access process.

In this embodiment, if a cell is indicated as “access-only”, or a state of a cell is deemed as “access-only”, a UE is allowed to camp on the cell only when the UE attempts to access to the cell immediately after camping on the cell successfully; otherwise, the UE is not allowed to camp on the cell.

In an implementation of this embodiment, if a cell is indicated as access-only, the indication information may further indicate that the UE is not allowed to camp on the cell, except that the UE attempts to access to the cell immediately after camping on the cell successfully.

In this implementation, besides indicating a state of a cell (access-only or non-access-only), in a case of indicating access-only, it is further indicated that what type of UE may camp on the cell, which may further provide a basis to the UE for determining whether to camp on the cell/access to the cell.

In an implementation of this embodiment, the indication information may be included in system information of the cell.The system information may be carried by common radio resource control (RRC) signaling or by a physical broadcast channel (PBCH), and this embodiment is not limited thereto.

In this implementation, the common RRC signaling may be first system information block (SIB1) signaling. For example, 1 bit, such as a bit “cellAcessOnly”, may be added to the SIB1 to indicate whether the cell is an access-only cell. In this example, the bit may be an enumerated bit, a value of which being “access only” or “not access only”, respectively indicating whether the cell is an access-only cell or not.

In this implementation, when multiple public land mobile networks (PLMNs) are indicated in the SIB1, a domain indicated by the bit “cellAcessOnly” may be universal to these PLMNs, and may also be dedicated for a certain PLMN, and this embodiment is not limited thereto.

In another implementation of this embodiment, the indication information may be carried by RRC signaling dedicated for UE.

In this implementation, the RRC signaling dedicated for UE carrying the indication information may be RRCConnectionRelease signaling. For example, the UE is at a state of being connected to the cell, that is, it is kept at a state of RRC_CONNECTED. When the base station of the cell transmits the RRCConnectionRelease signaling to the UE, that is, indicating the UE to disconnect the RRC connection with the cell, the base station of the cell may inform the UE whether the cell is an “access-only” cell or not by the indication information being carried in the RRCConnectionRelease signaling.

In an implementation of this embodiment, the method further includes:

step 102: the base station of the cell transmits invalidation indication information to the UE, the indication information indicating the UE a case where the indication message transmitted in step 101 invalidates; hence, the UE may determine whether the cell is an access-only cell for the UE according to the invalidation indication information; wherein, a particular determination method shall be described in an embodiment below.

In this embodiment, the cell selection method may be used by the UE for cell selection, and may also be used by the UE for cell reselection.

In the method of this embodiment, the current state of the cell (access-only or non-access-only) is notified to the UE, and the UE may determine as soon as possible whether to select the cell accordingly, thereby speeding up selection or reselection of suitable cells by the UE.

An embodiment of the present disclosure further provides a cell selection apparatus, as described in Embodiment 2 below. As principles of the cell selection apparatus are similar to that of the method of Embodiment 1, the implementation of the method of Embodiment 1 may be referred to for the implementation of the apparatus, with identical contents being not going to be described herein any further.

### Embodiment 2

An embodiment of the present disclosure provides a cell selection apparatus. FIG. 2 is a schematic diagram of a structure of the apparatus 200. As shown in FIG. 2, the apparatus 200 includes:

a transmitting unit 201 configured to transmit indication information to UE, the indication information indicating whether a cell covered by a base station to which the apparatus belongs is an access-only cell.

In an implementation of this embodiment, if the indication information indicates that the cell covered by the base station to which the apparatus belongs is an access-only cell, the indication information may further indicate that the UE is not allowed to camp on the cell, except that the UE attempts to access to the cell immediately after camping on the cell successfully.

In an implementation of this embodiment, the indication information is included in system information of the cell.

In this implementation, the system information may be carried by common radio resource control (RRC) signaling or by a physical broadcast channel (PBCH).

In this implementation, the common RRC signaling may be first system information block (SIB1) signaling.

In another implementation, the indication information may be carried by RRC signaling dedicated for UE.

In an implementation of this embodiment, the transmitting unit 201 is further configured to transmit invalidation indication information to the UE, so that the UE determines whether the cell is an access-only cell according to the invalidation indication information or according to the invalidation indication information and an ability of the UE.

In the apparatus of this embodiment, the current state of the cell (access-only) is notified to the UE, and the UE may determine as soon as possible whether to select the cell accordingly, thereby speeding up selection or reselection of suitable cells by the UE.

### Embodiment 3

An embodiment of the present disclosure provides a base station, including the cell selection apparatus described in Embodiment 2.

FIG. 3 is a schematic diagram of a structure of an implementation of the base station of an embodiment of the present disclosure. As shown in FIG. 3, the base station 300 may include a central processing unit (CPU) 301 and a memory 302, the memory 302 being coupled to the central processing unit 301. In this embodiment, the memory 302 may store various data, and may further store programs for information processing, and the programs are executed under control of the central processing unit 301, so as to receive various information transmitted by the UE, and transmit request information to the UE.

In an implementation, the function of the cell selection apparatus may be integrated into the central processing unit 301. In this implementation, the central processing unit 301 may be configured to: transmit indication information to the UE, the indication information indicates whether a cell covered by the base station to which the apparatus belongs is an access-only cell.

Alternatively, when the indication information indicates that the cell covered by the base station to which the apparatus belongs is an access-only cell, the indication information further indicates that the UE is not allowed to camp on the cell, except that the UE attempts to access to the cell immediately after camping on the cell successfully.

Alternatively, the indication information is included in system information of the cell.

Alternatively, the system information is carried by common radio resource control (RRC) signaling or by a physical broadcast channel (PBCH).

Alternatively, the common RRC signaling is first system information block (SIB1) signaling.

Alternatively, the indication information is carried by RRC signaling dedicated for the UE.

In another implementation, the cell selection apparatus and the central processing unit 301 may be configured separately. For example, the cell selection apparatus may be configured as a chip connected to the central processing unit 301, with its functions being realized under control of the central processing unit 301.

Furthermore, as shown in FIG. 3, the base station 300 may include a receiver 303 and an antenna 304, etc.; wherein, functions of these components are similar to those in the prior art, and shall not be described herein any further. It should be noted that the base station 300 does not necessarily include all the parts shown in FIG. 3. Furthermore, the base station 300 may include parts not shown in FIG. 3, and the prior art may be referred to.

In the base station of this embodiment, the current state of the cell (access-only) is notified to the UE, and the UE may determine as soon as possible whether to select the cell accordingly, thereby speeding up selection or reselection of suitable cells by the UE.

### Embodiment 4

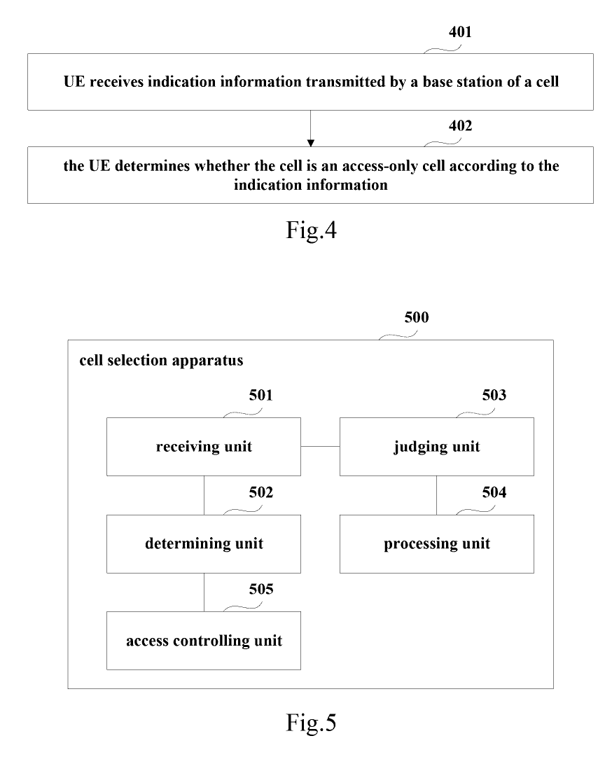

An embodiment of the present disclosure further provides a cell selection method, which is processing at a UE side corresponding to the method of Embodiment 1, with contents identical to those in Embodiment 1 being not going to be described herein any further. FIG. 4 is a flowchart of the method. Referring to FIG. 4, the method includes:

step 401: UE receives indication information transmitted by a base station of a cell; and

step 402: the UE determines whether the cell is an access-only cell according to the indication information.

In an implementation of this embodiment, the above indication information transmitted by the base station may be particular indication, and all UEs receiving the indication information deem that the cell is an access-only cell or a non-access-only cell. That is, the UE determines that the cell is an access-only cell when the indication information indicates that the cell is an access-only cell, and the UE determines that the cell is a non-access-only cell when the indication information indicates that the cell is a non-access-only cell.

In another implementation of this embodiment, the above indication information transmitted by the base station may be particular indication, and the UE receiving the indication information may determine whether the cell is an access-only cell or a non-access-only cell for it according to an ability of its own.

For example, when the indication information indicates that the cell is an access-only cell, if the UE is a UE of a first type, the UE determines that the cell is an access-only cell; and if the UE is a UE of a second type, the UE determines that the cell is a non-access-only cell. In this example, the UE of the first type is, for example, a UE of a relatively low ability, and the UE of the second type is, for example, a UE of a relatively high ability, and this embodiment is not limited thereto.

In a further implementation of this embodiment, besides the above indication information, the base station further transmits invalidation indication information, as described in Embodiment 1. In such a case, the UE receiving the indication information and the invalidation indication information may determine whether the cell is an access-only cell or a non-access-only cell for the UE according to the invalidation indication information or further according to the ability of its own.

For example, the indication information indicates that the cell is an access-only cell. And at the same time, the cell is dynamically turned on/off, and the base station of the cell transmits to the UE information related to dynamical turn-on/turn-off of the cell, referred to as dynamical turn-on/turn-off information, such as a dynamical turn-on/turn-off pattern. And the dynamical turn-on/turn-off information here is taken as the above invalidation indication information. If a UE of a high ability receives the indication information and the dynamical turn-on/turn-off information at the same time, and determines based on the dynamical turn-on/turn-off information that the UE of the high ability may normally camp on the cell during the dynamical turn-on/turn-off of the cell, the UE of the high ability may deem that the cell is a non-access-only cell. And if a UE of a low ability receives the indication information and the dynamical turn-on/turn-off information at the same time, and determines based on the dynamical turn-on/turn-off information that the UE of the low ability may not normally camp on the cell during the dynamical turn-on/turn-off of the cell, the UE of the low ability may deem that the cell is an access-only cell.

In an implementation of this embodiment, if the UE is performing random access (RA) in receiving the indication information and the random access process is not completed, the UE may take the cell as one of candidate cells for cell selection or reselection.

In another implementation of this embodiment, if the UE is not performing random access in receiving the indication information, the UE may abandon taking the cell as one of candidate cells for cell selection or reselection. And at this moment, the UE may store information related to the cell, such as a cell ID, a cell frequency, and/or a cell state, of the cell, so as to take it as a reference for subsequent cell selection or reselection. The cell state here may include that the cell is an access-only cell, and may include other contents, and this embodiment is not limited thereto.

In a further implementation of this embodiment, after storing the above information related to the cell, if the UE is performing random access and the random access process is not completed while the UE is to initiate one time of cell selection or reselection, the UE may take the cell as one of candidate cells for cell selection or reselection, and evaluate the candidate cell and compare the candidate cell with other candidate cells by using the stored information related to the cell in the process of the cell selection or reselection.

In this embodiment, if it is determined that the cell is an access-only cell, the UE may abandon camping on the cell when it wants only to camp on the cell and does not want to access to the cell, and may also first initiate a camping process first when it wants to access to the cell and then initiate random access to the cell after camping on the cell successfully, thereby speeding up selection of suitable cells by the UE.

In an implementation of this embodiment, the UE may start a timer after the UE camps on the cell. If the UE does not initiate the random access to the cell within timing of the timer, the UE performs cell reselection after the timer expires. And if the UE initiates the random access to the cell within timing of the timer, the timer may be stopped immediately, and the UE may perform normal random access.

In this embodiment, corresponding to Embodiment 1, the UE may obtain the indication of the base station by receiving the system information (such as the RRC signaling or the PBCH), and may also obtain the indication of the base station by receiving the RRC signaling dedicated for the UE, and this embodiment is not limited thereto.

For example, the UE is in a state of connecting to the cell, that is, it is kept in an RRC_CONNECTED state. When the base station of the cell transmits RRCConnectionRelease signaling to the UE, that is, indicating the UE to disconnect the RRC connection with the cell, the cell may inform the UE whether the cell is an “access-only” cell or a “non-access-only” cell by the indication being carried in the RRCConnectionRelease signaling. The UE starts to perform cell selection or reselection immediately after it disconnects the RRC connection with the base station, and will not take the base station as a candidate base station for cell reselection during the selection or reselection. The UE may further store information on the base station, and when the UE attempts to connect to a base station by initiating random access again, during the process of random access, the UE may further perform cell reselection, and take an “access-only” cell in cell reselection occurred during the process of random access as one of candidate base stations during this time of cell reselection process.

In the method of this embodiment, the UE may determine whether to camp on/access to the cell according to the received state of the cell (access-only), thereby speeding up selection or reselection of suitable cells by the UE.

An embodiment of the present disclosure further provides a cell selection apparatus, as described in Embodiment 5 below. As principles of the cell selection apparatus are similar to that of the method of Embodiment 4, the implementation of the method of Embodiment 4 may be referred to for the implementation of the apparatus, with identical contents being not going to be described herein any further.

### Embodiment 5

An embodiment of the present disclosure provides a cell selection apparatus. FIG. 5 is a schematic diagram of a structure of the apparatus 500. Referring to FIG. 5, the apparatus 500 includes:

a receiving unit 501 configured to receive indication information transmitted by a base station of a cell; and

a determining unit 502 configured to determine whether the cell is an access-only cell according to the indication information.

In an implementation of this embodiment, if the indication information indicates that the cell is an access-only cell, the determining unit 502 determines that the cell is an access-only cell accordingly.

In another implementation of this embodiment, if the indication information indicates that the cell is an access-only cell, the determining unit 502 determines whether the cell is an access-only cell according to received invalidation indication information transmitted by the base station and/or an ability of the UE.

For example, if the UE to which the apparatus belongs is a UE of a first type, the determining unit 502 determines that the cell is an access-only cell; and if the UE to which the apparatus belongs is a UE of a second type, the determining unit 502 determines that the cell is a non-access-only cell.

In a further implementation of this embodiment, if the indication information indicates that the cell is a non-access-only cell, the determining unit 502 determines that the cell is a non-access-only cell, and at this moment, the UE may perform cell selection or reselection in a conventional manner.

In an implementation of this embodiment, the apparatus further includes:

a judging unit 503 configured to judge whether the UE to which the apparatus belongs is performing random access when the receiving unit 501 receives the indication information; and

a processing unit 504 configured to take the cell as one of candidate cells on which the UE performs cell reselection when it is judged by the judging unit 503 that the UE is performing random access, and store information related to the cell when it is judged by the judging unit 503 that the UE is not performing random access. In this implementation, the information related to the cell includes a cell ID, a cell frequency, and/or a cell state, of the cell. In this implementation, the cell state includes that the cell is an access-only cell.

In an implementation of this embodiment, the processing unit 504 is further configured to take the cell as one of candidate cells on which the UE performs cell selection or reselection when the UE is performing random access and the random access process is not completed while the UE is to initiate the cell selection or reselection, and evaluate the candidate cell and compare the candidate cell with other candidate cells by using the stored information related to the cell in the process of the cell selection or reselection.

In an implementation of this embodiment, the apparatus further includes:

an access controlling unit 505 configured to start a predetermined timer after the UE to which the apparatus belongs camps on the cell when the determining unit 502 determines that the cell is an access-only cell, judge whether the UE initiates random access to the cell within the timing of the timer, perform cell selection or reselection after the timer expires if the UE does not initiate the random access to the cell, and terminate the timing of the timer if the UE initiates the random access to the cell.

In the apparatus of this embodiment, the UE may determine whether to camp on/access to the cell according to the received state of the cell (access-only), thereby speeding up selection or reselection of suitable cells by the UE.

### Embodiment 6

An embodiment of the present disclosure provides UE, including the cell selection apparatus described in Embodiment 5.

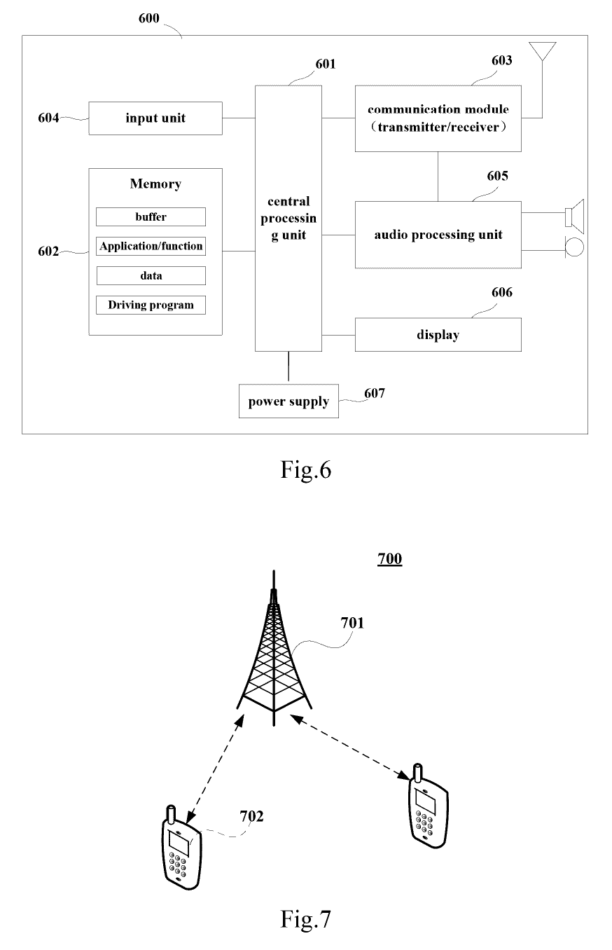

FIG. 6 is a schematic diagram of a structure of an implementation of the UE 600 of an embodiment of the present disclosure. As shown in FIG. 6, the UE 600 may include a central processing unit 601 and a memory 602, the memory 602 being coupled to the central processing unit 601. It should be noted that this figure is illustrative only, and other types of structures may also be used, so as to supplement or replace this structure and achieve telecommunications function or other functions.

In an implementation, the function of the cell selection apparatus may be integrated into the central processing unit 601. In this implementation, the central processing unit 601 may be configured to:

receive indication information transmitted by a base station of a cell; and

determine whether the cell is an access-only cell according to the indication information.

In an implementation, if the indication information indicates that the cell is an access-only cell, the central processing unit 601 is configured to determine that the cell is an access-only cell accordingly.

In an implementation, if the indication information indicates that the cell is an access-only cell, the central processing unit 601 is configured to determine whether the cell is an access-only cell according to received invalidation indication information transmitted by the base station and/or an ability of itself.

In this embodiment, if the UE is a UE of a first type, the central processing unit 601 is configured to determine that the cell is an access-only cell.

If the UE is a UE of a second type, the central processing unit 601 is configured to determine that the cell is a non-access-only cell.

In an implementation, if the indication information indicates that the cell is a non-access-only cell, the central processing unit 601 is configured to determine that the cell is a non-access-only cell.

In an implementation, the central processing unit 601 is further configured to take the cell as one of candidate cells for cell reselection or selection when the UE is performing random access in receiving the indication information.

In an implementation, the central processing unit 601 is further configured to store information related to the cell in the memory 602 when the UE is not performing random access in receiving the indication information. In this implementation, the information related to the cell includes a cell ID, a cell frequency, and/or a cell state, of the cell. And in this implementation, the cell state includes that the cell is an access-only cell.

In an implementation, the central processing unit 601 is further configured to take the cell as one of candidate cells for cell selection or reselection when the UE is performing random access and the random access process is not completed while the UE is to initiate one time of cell selection or reselection, and evaluate the candidate cell and compare the candidate cell with other candidate cells by using the stored information related to the cell in the process of the cell selection or reselection.

In an implementation, if it is determined that the cell is an access-only cell, the central processing unit 601 is configured to start a timer after the UE camps on the cell; and if the UE does not initiate random access to the cell within timing of the timer, the central processing unit 601 is configured to perform reselection after the timer expires.

In another implementation, the cell selection apparatus and the central processing unit 601 may be configured separately. For example, the cell selection apparatus may be configured as a chip connected to the central processing unit 601, with its functions being realized under control of the central processing unit 601.

As shown in FIG. 6, the UE 600 may further include a communication module 603, an input unit 604, an audio processing unit 605, a display 606, and a power supply 607. It should be noted that the UE 600 does not necessarily include all the parts shown in FIG. 6. Furthermore, the UE 600 may further include other parts than those shown in FIG. 6, and the prior art may be referred to.

As shown in FIG. 6, the central processing unit 601 is sometimes referred to as a controller or control, and may include a microprocessor or other processor devices and/or logic devices. The central processing unit 601 receives input and controls operations of every component of the UE 600.

In this embodiment, the memory 602 may be, for example, one or more of a buffer memory, a flash memory, a hard drive, a mobile medium, a volatile memory, a nonvolatile memory, or other suitable devices. The memory 602 may store the above information, and may further store programs executing related information. And the central processing unit 601 may execute the programs stored in the memory 602, so as to realize information storage or processing, etc. Functions of other parts are similar to those of the prior art, which shall not be described herein any further. The parts of the UE 600 may be realized by specific hardware, firmware, software, or any combination thereof, without departing from the scope of the present disclosure.

In the UE of this embodiment, the UE may determine whether to camp on/access to the cell according to the received state of the cell (access-only), thereby speeding up selection or reselection of suitable cells.

### Embodiment 7

An embodiment of the present disclosure further provides a communication system, including the base station described in Embodiment 3 and the UE described in Embodiment 6.

FIG. 7 is a schematic diagram of a structure of the communication system of an embodiment of the present disclosure. As shown in FIG. 7, the communication system 700 includes a base station 701 and UE 702. In this embodiment, the base station 701 may be the base station 300 described in Embodiment 3, and the UE 702 may be the UE 600 described in Embodiment 6. In this embodiment,

the base station 701 is configured to transmit indication information to the UE, the indication information indicating whether a cell covered by the base station is an access-only cell;

and the UE 702 is configured to receive the indication information, and determine whether the cell is an access-only cell according to the indication information.

As the base station and the UE are respectively described in Embodiment 3 and Embodiment 6 in detail, the contents of which being incorporated herein and shall not be described herein any further.

In the communication system of this embodiment, the UE may determine whether to camp on/access to the cell according to the received state of the cell (access-only), thereby speeding up selection or reselection of suitable cells by the UE.

An embodiment of the present disclosure further provides a computer-readable program, wherein when the program is executed in a base station, the program enables a base station to carry out the cell selection method as described in Embodiment 1.

An embodiment of the present disclosure provides a storage medium in which a computer-readable program is stored, wherein the computer-readable program enables a base station to carry out the cell selection method as described in Embodiment 1.

An embodiment of the present disclosure further provides a computer-readable program, wherein when the program is executed in UE, the program enables UE to carry out the cell selection method as described in Embodiment 4.

An embodiment of the present disclosure provides a storage medium in which a computer-readable program is stored, wherein the computer-readable program enables UE to carry out the cell selection method as described in Embodiment 4.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

What is claimed is:

1. A cell selection apparatus, comprising:
a transmitting unit configured to transmit indication information to user equipment (UE), the indication information indicating whether a cell covered by a base station to which the apparatus belongs is an access-only cell.

2. The apparatus according to claim 1, wherein if the indication information indicates that the cell covered by the base station to which the apparatus belongs is an access-only cell, the indication information further indicates that the UE is not allowed to camp on the cell, except that the UE attempts to access to the cell immediately after camping on the cell successfully.

3. The apparatus according to claim 1, wherein the indication information is included in system information of the cell.

4. The apparatus according to claim 3, wherein the system information is carried by common radio resource control (RRC) signaling or by a physical broadcast channel (PBCH).

5. The apparatus according to claim 4, wherein the common RRC signaling is first system information block (SIB1) signaling.

6. The apparatus according to claim 1, wherein the indication information is carried by RRC signaling dedicated for UE.

7. The apparatus according to claim 1, wherein the transmitting unit is further configured to transmit invalidation indication information to the UE, so that the UE determines whether the cell is an access-only cell according to the invalidation indication information or according to the invalidation indication information and an ability of the UE.

8. A cell selection apparatus, comprising:
a receiving unit configured to receive indication information transmitted by a base station of a cell; and
a determining unit configured to determine whether the cell is an access-only cell according to the indication information.

9. The apparatus according to claim 8, wherein the determining unit determines that the cell is an access-only cell when the indication information indicates that the cell is an access-only cell.

10. The apparatus according to claim 8, wherein the determining unit determines whether the cell is an access-only cell according to received invalidation indication information transmitted by the base station and/or an ability of its own when the indication information indicates that the cell is an access-only cell.

11. The apparatus according to claim 10, wherein,
if the UE to which the apparatus belongs is a UE of a first type, the determining unit determines that the cell is an access-only cell;
and if the UE to which the apparatus belongs is a UE of a second type, the determining unit determines that the cell is a non-access-only cell.

12. The apparatus according to claim 8, wherein the determining unit determines that the cell is a non-access-only cell when the indication information indicates that the cell is a non-access-only cell.

13. The apparatus according to claim 8, wherein the apparatus further comprises:
a judging unit configured to judge whether the UE to which the apparatus belongs is performing random access when the receiving unit receives the indication information; and
a processing unit configured to take the cell as one of candidate cells on which the UE performs cell reselection when it is judged by the judging unit that the UE is performing random access.

14. The apparatus according to claim 13, wherein,
the processing unit is further configured to store information related to the cell when it is judged by the judging unit that the UE is not performing random access.

15. The apparatus according to claim 14, wherein the information related to the cell comprises a cell ID, a cell frequency, and/or a cell state, of the cell.

16. The apparatus according to claim 15, wherein the cell state comprises that the cell is an access-only cell.

17. The apparatus according to claim 14, wherein,
the processing unit is further configured to take the cell as one of candidate cells on which the UE performs cell selection or reselection when the UE is performing random access and the UE is to initiate the cell selection or reselection, and evaluate the candidate cell and compare the candidate cell with other candidate cells by using the stored information related to the cell in the process of the cell selection or reselection.

18. The apparatus according to claim 8, wherein the apparatus further comprises:
an access controlling unit configured to start a timer after the UE to which the apparatus belongs camps on the cell when the determining unit determines that the cell is an access-only cell, and perform cell selection or reselection after the timer expires when the UE does not initiate random access to the cell within timing of the timer.

19. A communication system, comprising a base station and UE, wherein,
the base station is configured to transmit indication information to the UE, the indication information indicating whether a cell covered by the base station is an access-only cell;
and the UE is configured to receive the indication information, and determine whether the cell is an access-only cell according to the indication information.
